(19) United States
(12) Patent Application Publication
(10) Pub. No.: US 2021/0341162 A1
(43) Pub. Date: Nov. 4, 2021

(54) SPLIT THERMOSTAT

(71) Applicant: Johnson Controls Technology Company, Auburn Hills, MI (US)

(72) Inventors: Sayan Chakraborty, Brookfield, WI (US); Rohit Madhav Udavant, Philadelphia, PA (US)

(73) Assignee: Johnson Controls Technology Company, Auburn Hills, MI (US)

(21) Appl. No.: 16/863,790

(22) Filed: Apr. 30, 2020

(51) Int. Cl. F24F 11/30; F24F 11/52; F24F 11/58; F24F 11/64; F24F 11/65; G05B 19/042

(52) U.S. Cl. CPC F24F 11/30; F24F 11/52; F24F 11/58; F24F 2110/10; F24F 11/65; G05B 19/042; F24F 11/64

(57) ABSTRACT

A building heating, ventilation or air conditioning (HVAC) system is shown. The system includes a display device. The display device includes a first processing circuit, the first processing circuit provides a setpoint to one or more virtual controllers. Execution of one of the one or more virtual controllers with the setpoint of an environmental condition of the building generates one or more control commands. The processing circuit further provides the one or more control commands to a building equipment. The system further includes the building equipment that receives the one or more control commands to control the environmental condition of the building.

### BACKGROUND

The present disclosure relates generally to building systems that control environmental conditions of a building. The present disclosure relates more particularly to thermostats of a building system.

Conventional methods of implementing a thermostat in a building rely on on-premises thermostats that need to be installed within the building. There exists a need to implement a virtual thermostat that can be located off-premises and can be communicatively connected to the building HVAC system via a cloud network.

### SUMMARY

One implementation of the present disclosure is a building heating, ventilation or air conditioning (HVAC) system is shown. The system includes a display device. The display device includes a first processing circuit, the first processing circuit provides a setpoint to one or more virtual controllers. Execution of one of the one or more virtual controllers with the setpoint of an environmental condition of the building generates one or more control commands. The processing circuit further provides the one or more control commands to a building equipment. The system further includes the building equipment that receives the one or more control commands to control the environmental condition of the building.

In some embodiments, providing a setpoint to one or more virtual controllers includes providing at least one of a temperature, position, fluid flow, rotation, or air quality setpoint to one or more virtual controllers.

In some embodiments, the display device includes a user interface for receiving the setpoint, wherein the display device is a wall-mounted thermostat display or a mobile device or a computer. In some embodiments the building equipment is a furnace or boiler or chiller or heater. In some embodiments, the one or more virtual controllers are virtual thermostats.

In some embodiments, the system further includes a building equipment interface that receives the one or more control commands via the one or more virtual controllers and operates the building equipment to achieve the setpoint.

In some embodiments, the building equipment and the equipment interface are at least one of separate devices, wherein the building equipment is connected to the equipment interface via one or more communication wires or integrated together, wherein the equipment interface is a component of the building equipment.

In some embodiments, the processing circuit of the device and the equipment interface are each configured to implement a communication interface module comprising a plurality of predefined communication rules, wherein the processing circuit is configured to communicate one or more control commands to the equipment interface via the plurality of predefined communications rules.

In some embodiments, the one or more virtual controllers are located in a cloud network. In some embodiments, the display device is a smart display device configured to communicate with the virtual thermostat via the cloud network, the display device configured to receive operational data of the building HVAC system from the virtual controller.

In some embodiments, the display device is located on premises such that the building equipment and the display device are located in a same building. In some embodiments, the building HVAC system further comprises one or more sensors configured to provide sensor data for the setpoint of an environmental condition and provides the sensor data to the virtual controller via the cloud network.

In some embodiments, the processing circuit is further configured to receive an indication to instantiate a plurality of virtual controllers for one or more buildings and execute each of the plurality of virtual controllers to generate particular control decisions for each of the plurality of virtual controllers.

In some embodiments, the communication interface module comprises an application programming interface (API).

Another implementation of the present disclosure is a method for controlling a building heating, ventilation, or air conditioning (HVAC) system. The method includes receiving a setpoint from a display device, the temperature setpoint provided by the display device via a cloud network to a virtual controller. The method further includes processing the setpoint within a virtual controller located within the cloud network and determine a set of control signals that, when provided to a building equipment, adjust a temperature in the HVAC system to reach the setpoint. The method further includes providing control signals from the virtual controller to the building equipment to control the environmental condition of the building.

In some embodiments, the display device comprises a user interface for receiving the setpoint, wherein the display device is a wall-mounted thermostat display or a mobile device or a computer. In some embodiments, the building equipment is a furnace or boiler or chiller or heater. In some embodiments, the one or more virtual controllers are virtual thermostats.

In some embodiments, the method further includes receiving, via a display device, instructions to provide a change a temperature setpoint in the building HVAC system and providing, via the display device, the temperature setpoint to the one or more virtual thermostats via the cloud network. In some embodiments, the virtual controller is a virtual thermostat.

In some embodiments, the display device is located on premises such that the building equipment and the display device are located in a same building. In some embodiments, the building HVAC system further comprises one or more sensors configured to provide sensor data for the setpoint of an environmental condition and provides the sensor data to the virtual controller via the cloud network.

In some embodiments, the system further includes a building equipment interface configured to receive the one or more control commands via the one or more virtual controllers and operate the building equipment to achieve the setpoint.

In some embodiments, the building equipment and the equipment interface are at least one of separate devices, wherein the building equipment is connected to the equipment interface via one or more communication wires or integrated together, wherein the equipment interface is a component of the building equipment.

In some embodiments, the method further includes implementing a communication interface module comprising a plurality of predefined communication rules and communicating one or more control commands to the equipment interface via the plurality of predefined communications rules.

In some embodiments, the communication interface module comprises an application programming interface (API).

Another implementation of the present disclosure is a thermostat for a heating, ventilation, or air conditioning (HVAC) system. The thermostat includes a processing circuit including one or more processors and memory storing instructions that, when executed by the one or more processors, cause the one or more processors to perform operations. The operations include receiving a temperature setpoint from a display device, the temperature setpoint provided by the display device via a cloud network to a virtual thermostat. The operations further include processing the temperature setpoint within a virtual thermostat located within the cloud network and determining a set of control signals that, when provided to an equipment module, adjust a temperature in the HVAC system to reach the temperature setpoint. The operations further include providing control signals from the virtual thermostat to an equipment module, the equipment module configured to operate a plurality of building equipment to control the temperature in the HVAC system.

In some embodiments, the operations further include receiving, via a display device, instructions to provide a change a temperature setpoint in the building HVAC system and providing, via the display device, the temperature setpoint to the one or more virtual thermostats via the cloud network.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a perspective schematic drawing of a building equipped with a HVAC system, according to some embodiments.

FIG. 2 is a diagram of a waterside system which can be implemented in the HVAC system of FIG. 1, according to some embodiments.

FIG. 3 is a diagram of an airside system which can be implemented in the HVAC system of FIG. 1, according to some embodiments.

FIG. 4 is a schematic of a thermostat, which can be implemented in the HVAC system of FIG. 1, according to some embodiments.

FIG. 5 is a perspective schematic drawing of a building equipped with a residential heating and cooling system, which can be implemented in the HVAC system of FIG. 1, according to some embodiments.

FIG. 6 is a schematic of a residential HVAC system, according to some embodiments.

FIG. 7 is a diagram of a headless thermostat, according to some embodiments.

FIG. 8 is a diagram of a headless thermostat, according to some embodiments.

FIG. 9A is a block diagram of an HVAC system which can be used in the HVAC system of FIG. 1, according to some embodiments.

FIG. 9B is a block diagram of an HVAC system which can be used in the HVAC system of FIG. 1, according to some embodiments.

FIG. 10 is a diagram of a connected thermostat, according to some embodiments.

FIG. 11 is a diagram of a split thermostat, which can be used in the system of FIG. 9, according to some embodiments.

FIG. 12 is a block diagram of an HVAC system which can be used in the HVAC system of FIG. 1, according to some embodiments.

FIG. 13 is a block diagram of an HVAC system which can be used in the HVAC system of FIG. 1, according to some embodiments.

FIG. 14 is a block diagram of an HVAC system which can be used in the HVAC system of FIG. 1, according to some embodiments.

FIG. 15 is a block diagram of a server for a virtual thermostat which can be used in the system of FIG. 9, according to some embodiments.

FIG. 16 is a process for controlling an HVAC system which can be implemented by the thermostat of FIG. 14, according to some embodiments.

FIG. 17 is a process for controlling an HVAC system which can be implemented by the thermostat of FIG. 14, according to some embodiments.

### DETAILED DESCRIPTION

### Overview

Referring generally to the FIGURES, a control system in a building is shown. Buildings may include HVAC systems that can be configured to monitor and control temperature within a building zone via one or more thermostats.

In some embodiments of the present disclosure, the thermostat may be a “split” thermostat, such that the display features of the thermostat and the input/output (I/O) functionality are not coupled together (e.g., physically located together). The split thermostat may include a display device (e.g., smartphone, tablet) capable of providing various setpoints (e.g., temperature setpoint, humidity setpoint, etc.) to the equipment interface of the thermostat. The equipment interface may include processing (e.g., I/O functionality, etc.) that does not require a coupled interface to receive control signals. Instead, the thermostat processing may be performed via a cloud network, wherein a virtual thermostat includes processing off-premises (e.g., over the cloud network) stored on a server capable of processing the received instructions from the display device and providing control signals to the equipment interface. This can reduce installation times for technicians, as it requires no display-based thermostat to be installed in a residential or commercial environment.

As described herein, the various environmental parameters monitored, measured, and controlled may include but are not limited to: temperature, humidity, air quality, water pressure, water temperature, coolant pressure, coolant pressure, and any other parameter capable of being monitored in an HVAC system. As described herein the processing performed off-premise (e.g., via a cloud, etc.) can be spread out over one or more servers and/or processing circuits.

As described herein, setpoints may refer to any and all types of desired (e.g., target) values for a variable in an HVAC system. This may generally refer to temperature, but may also include position, fluid flow, rotation, and air quality. In some embodiments, one or more thermostats described herein can receive several types of setpoints and are limited to regulating temperature in an HVAC system. Additionally, as described herein, virtual thermostats may refer more generally to virtual controllers capable of receiving a variety of inputs for control/monitoring.

### Building and Residential HVAC Systems

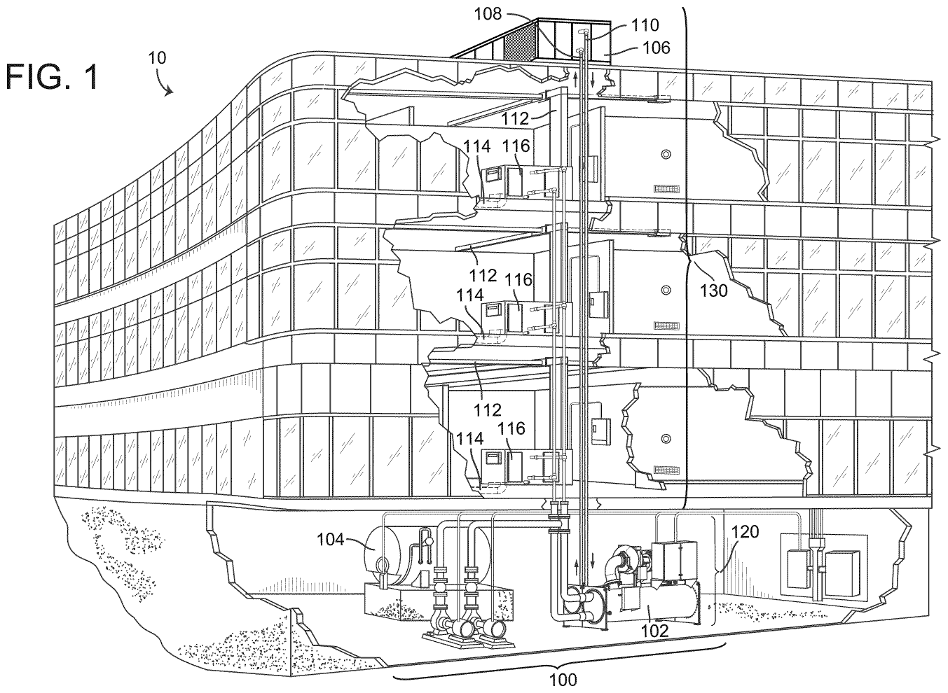

Referring now to FIG. 1, a perspective view of a building 10 is shown. Building 10 is served by a building management system (BMS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

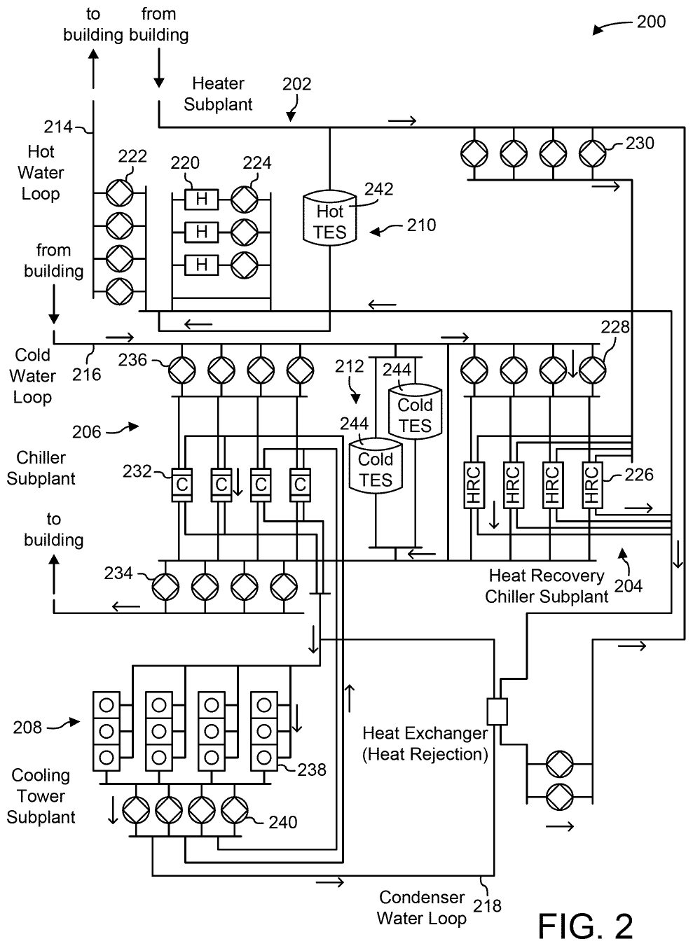

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

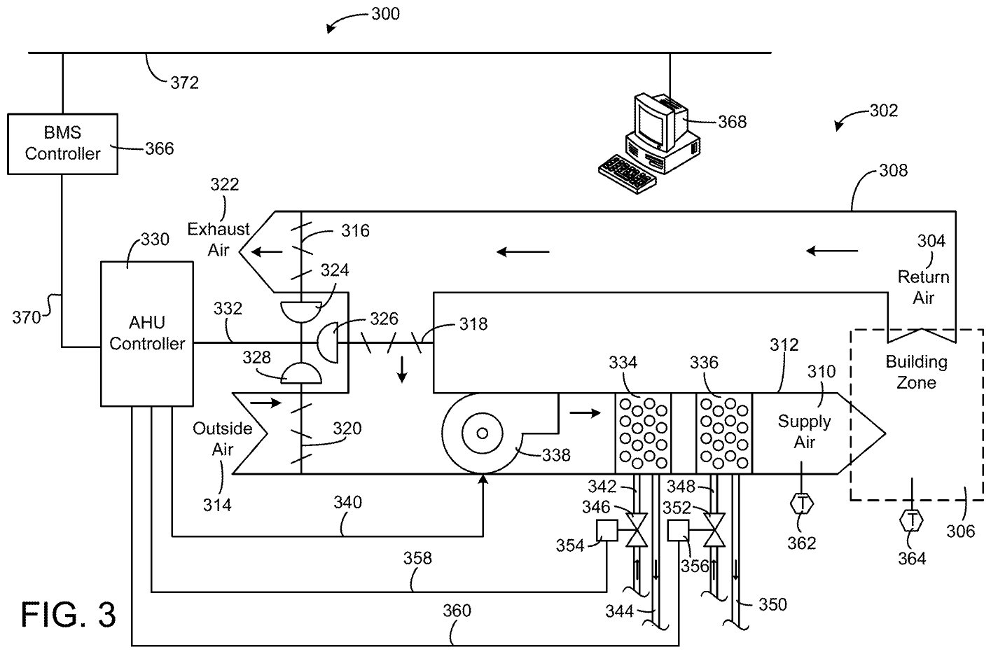

Referring now to FIG. 3, a block diagram of an airside system 300 is shown, according to an example embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, duct 112, duct 114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

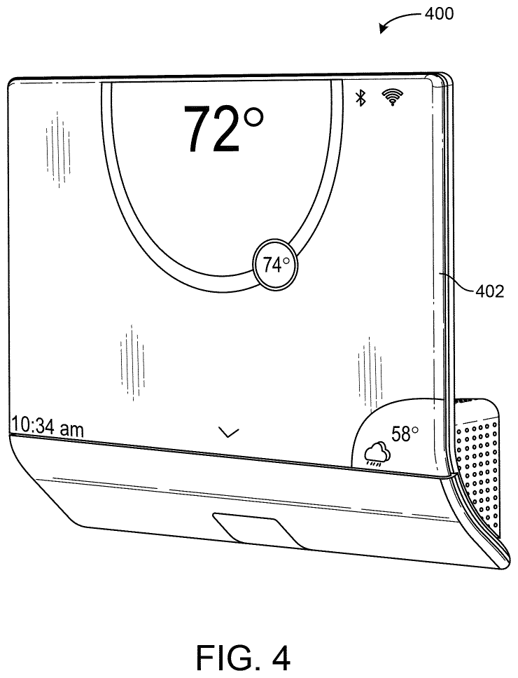

Referring now to FIG. 4, a drawing of a thermostat 400 for controlling building equipment is shown, according to an exemplary embodiment. The thermostat 400 is shown to include a display 402. The display 402 may be an interactive display that can display information to a user and receive input from the user. The display may be transparent such that a user can view information on the display and view the surface located behind the display. Thermostats with transparent and cantilevered displays are described in further detail in U.S. patent application Ser. No. 15/146,649 filed May 4, 2016, the entirety of which is incorporated by reference herein.

The display 402 can be a touchscreen or other type of electronic display configured to present information to a user in a visual format (e.g., as text, graphics, etc.) and receive input from a user (e.g., via a touch-sensitive panel). For example, the display 402 may include a touch-sensitive panel layered on top of an electronic visual display. A user can provide inputs through simple or multi-touch gestures by touching the display 402 with one or more fingers and/or with a stylus or pen. The display 402 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 402 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display 202 is configured to present visual media (e.g., text, graphics, etc.) without requiring a backlight.

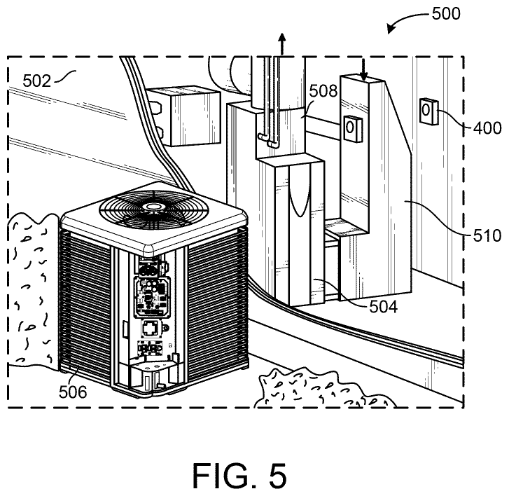

Referring now to FIG. 5, a residential heating and cooling system 500 is shown, according to an exemplary embodiment. The residential heating and cooling system 500 may provide heated and cooled air to a residential structure. Although described as a residential heating and cooling system 500, embodiments of the systems and methods described herein can be utilized in a cooling unit or a heating unit in a variety of applications including commercial HVAC units (e.g., roof top units). In general, a residence 502 includes refrigerant conduits that operatively couple an indoor unit 504 to an outdoor unit 506. Indoor unit 504 may be positioned in a utility space, an attic, a basement, and so forth. Outdoor unit 506 is situated adjacent to a side of residence 502. Refrigerant conduits transfer refrigerant between indoor unit 504 and outdoor unit 506, typically transferring primarily liquid refrigerant in one direction and primarily vaporized refrigerant in an opposite direction.

When system 500 is operating as an air conditioner, a coil in outdoor unit 506 serves as a condenser for recondensing vaporized refrigerant flowing from indoor unit 504 to outdoor unit 506 via one of the refrigerant conduits. In these applications, a coil of the indoor unit 504, designated by the reference numeral 508, serves as an evaporator coil. Evaporator coil 508 receives liquid refrigerant (which may be expanded by an expansion device, not shown) and evaporates the refrigerant before returning it to outdoor unit 506.

Outdoor unit 506 draws in environmental air through its sides, forces the air through the outer unit coil using a fan, and expels the air. When operating as an air conditioner, the air is heated by the condenser coil within the outdoor unit 506 and exits the top of the unit at a temperature higher than it entered the sides. Air is blown over indoor coil 508 and is then circulated through residence 502 by means of ductwork 510, as indicated by the arrows entering and exiting ductwork 510. The overall system 500 operates to maintain a desired temperature as set by thermostat 400. When the temperature sensed inside the residence 502 is higher than the set point on the thermostat 400 (with the addition of a relatively small tolerance), the air conditioner will become operative to refrigerate additional air for circulation through the residence 502. When the temperature reaches the set point (with the removal of a relatively small tolerance), the unit can stop the refrigeration cycle temporarily.

In some embodiments, the system 500 configured so that the outdoor unit 506 is controlled to achieve a more elegant control over temperature and humidity within the residence 502. The outdoor unit 506 is controlled to operate components within the outdoor unit 506, and the system 500, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

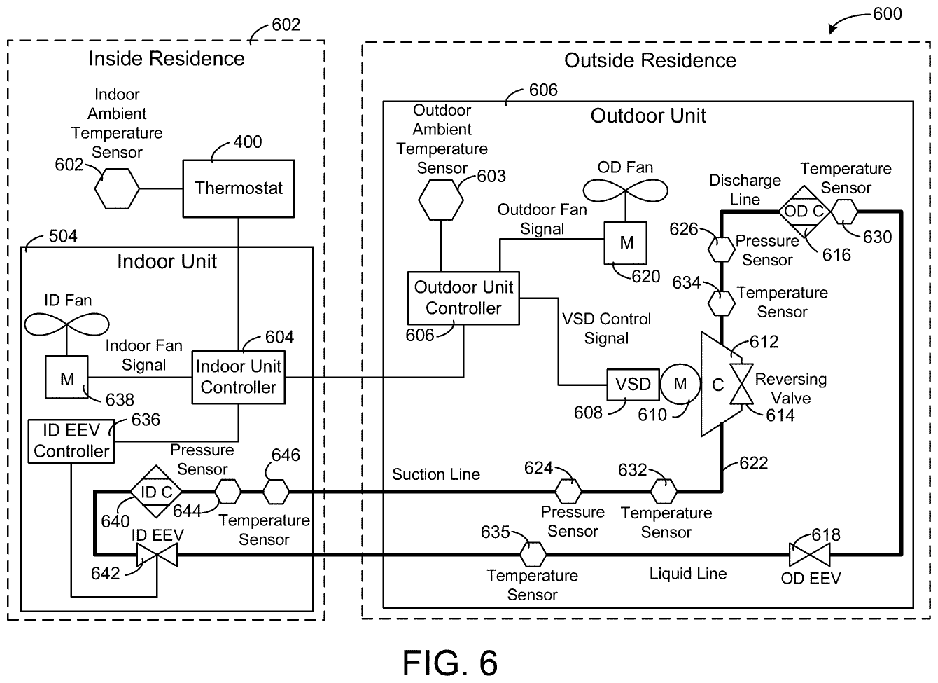

Referring now to FIG. 6, an HVAC system 600 is shown according to an exemplary embodiment. Various components of system 600 are located inside residence 502 while other components are located outside residence 502. Outdoor unit 506, as described with reference to FIG. 5, is shown to be located outside residence 502 while indoor unit 504 and thermostat 400, as described with reference to FIG. 4, are shown to be located inside the residence 502. In various embodiments, the thermostat 400 can cause the indoor unit 504 and the outdoor unit 506 to heat residence 502. In some embodiments, the thermostat 400 can cause the indoor unit 504 and the outdoor unit 506 to cool the residence 502. In other embodiments, the thermostat 400 can command an airflow change within the residence 502 to adjust the humidity within the residence 502.

The thermostat 400 can be configured to generate control signals for indoor unit 504 and/or outdoor unit 506. The thermostat 400 is shown to be connected to an indoor ambient temperature sensor 602, and an outdoor unit controller 606 is shown to be connected to an outdoor ambient temperature sensor 603. The indoor ambient temperature sensor 602 and the outdoor ambient temperature sensor 603 may be any kind of temperature sensor (e.g., thermistor, thermocouple, etc.). The thermostat 400 may measure the temperature of residence 502 via the indoor ambient temperature sensor 602. Further, the thermostat 400 can be configured to receive the temperature outside residence 502 via communication with the outdoor unit controller 606. In various embodiments, the thermostat 400 generates control signals for the indoor unit 504 and the outdoor unit 506 based on the indoor ambient temperature (e.g., measured via indoor ambient temperature sensor 602), the outdoor temperature (e.g., measured via the outdoor ambient temperature sensor 603), and/or a temperature set point.

The indoor unit 504 and the outdoor unit 506 may be electrically connected. Further, indoor unit 504 and outdoor unit 506 may be coupled via conduits 622. The outdoor unit 506 can be configured to compress refrigerant inside conduits 622 to either heat or cool the building based on the operating mode of the indoor unit 504 and the outdoor unit 506 (e.g., heat pump operation or air conditioning operation). The refrigerant inside conduits 622 may be any fluid that absorbs and extracts heat. For example, the refrigerant may be hydro fluorocarbon (HFC) based R-410A, R-407C, and/or R-134a.

The outdoor unit 506 is shown to include the outdoor unit controller 606, a variable speed drive 608, a motor 610 and a compressor 612. The outdoor unit 506 can be configured to control the compressor 612 and to further cause the compressor 612 to compress the refrigerant inside conduits 622. In this regard, the compressor 612 may be driven by the variable speed drive 608 and the motor 610. For example, the outdoor unit controller 606 can generate control signals for the variable speed drive 608. The variable speed drive 608 (e.g., an inverter, a variable frequency drive, etc.) may be an AC-AC inverter, a DC-AC inverter, and/or any other type of inverter. The variable speed drive 608 can be configured to vary the torque and/or speed of the motor 610 which in turn drives the speed and/or torque of compressor 612. The compressor 612 may be any suitable compressor such as a screw compressor, a reciprocating compressor, a rotary compressor, a swing link compressor, a scroll compressor, or a turbine compressor, etc.

In some embodiments, the outdoor unit controller 606 is configured to process data received from the thermostat 400 to determine operating values for components of the system 600, such as the compressor 612. In one embodiment, the outdoor unit controller 606 is configured to provide the determined operating values for the compressor 612 to the variable speed drive 608, which controls a speed of the compressor 612. The outdoor unit controller 606 is controlled to operate components within the outdoor unit 506, and the indoor unit 504, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 606 can control a reversing valve 614 to operate system 600 as a heat pump or an air conditioner. For example, the outdoor unit controller 606 may cause reversing valve 614 to direct compressed refrigerant to the indoor coil 508 while in heat pump mode and to an outdoor coil 616 while in air conditioner mode. In this regard, the indoor coil 508 and the outdoor coil 616 can both act as condensers and evaporators depending on the operating mode (i.e., heat pump or air conditioner) of system 600.

Further, in various embodiments, outdoor unit controller 606 can be configured to control and/or receive data from an outdoor electronic expansion valve (EEV) 618. The outdoor electronic expansion valve 618 may be an expansion valve controlled by a stepper motor. In this regard, the outdoor unit controller 606 can be configured to generate a step signal (e.g., a PWM signal) for the outdoor electronic expansion valve 618. Based on the step signal, the outdoor electronic expansion valve 618 can be held fully open, fully closed, partial open, etc. In various embodiments, the outdoor unit controller 606 can be configured to generate step signal for the outdoor electronic expansion valve 618 based on a subcool and/or superheat value calculated from various temperatures and pressures measured in system 600. In one embodiment, the outdoor unit controller 606 is configured to control the position of the outdoor electronic expansion valve 618 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 606 can be configured to control and/or power outdoor fan 620. The outdoor fan 620 can be configured to blow air over the outdoor coil 616. In this regard, the outdoor unit controller 606 can control the amount of air blowing over the outdoor coil 616 by generating control signals to control the speed and/or torque of outdoor fan 620. In some embodiments, the control signals are pulse wave modulated signals (PWM), analog voltage signals (i.e., varying the amplitude of a DC or AC signal), and/or any other type of signal. In one embodiment, the outdoor unit controller 606 can control an operating value of the outdoor fan 620, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 506 may include one or more temperature sensors and one or more pressure sensors. The temperature sensors and pressure sensors may be electrically connected (i.e., via wires, via wireless communication, etc.) to the outdoor unit controller 606. In this regard, the outdoor unit controller 606 can be configured to measure and store the temperatures and pressures of the refrigerant at various locations of the conduits 622. The pressure sensors may be any kind of transducer that can be configured to sense the pressure of the refrigerant in the conduits 622. The outdoor unit 506 is shown to include pressure sensor 624. The pressure sensor 624 may measure the pressure of the refrigerant in conduit 622 in the suction line (i.e., a predefined distance from the inlet of compressor 612). Further, the outdoor unit 506 is shown to include pressure sensor 626. The pressure sensor 626 may be configured to measure the pressure of the refrigerant in conduits 622 on the discharge line (e.g., a predefined distance from the outlet of compressor 612).

The temperature sensors of outdoor unit 506 may include thermistors, thermocouples, and/or any other temperature sensing device. The outdoor unit 506 is shown to include temperature sensor 630, temperature sensor 632, temperature sensor 634, and temperature sensor 636. The temperature sensors (i.e., temperature sensor 630, temperature sensor 632, temperature sensor 635, and/or temperature sensor 646) can be configured to measure the temperature of the refrigerant at various locations inside conduits 622.

Referring now to the indoor unit 504, the indoor unit 504 is shown to include indoor unit controller 604, indoor electronic expansion valve controller 636, an indoor fan 638, an indoor coil 640, an indoor electronic expansion valve 642, a pressure sensor 644, and a temperature sensor 646. The indoor unit controller 604 can be configured to generate control signals for indoor electronic expansion valve controller 642. The signals may be set points (e.g., temperature set point, pressure set point, superheat set point, subcool set point, step value set point, etc.). In this regard, indoor electronic expansion valve controller 636 can be configured to generate control signals for indoor electronic expansion valve 642. In various embodiments, indoor electronic expansion valve 642 may be the same type of valve as outdoor electronic expansion valve 618. In this regard, indoor electronic expansion valve controller 636 can be configured to generate a step control signal (e.g., a PWM wave) for controlling the stepper motor of the indoor electronic expansion valve 642. In this regard, indoor electronic expansion valve controller 636 can be configured to fully open, fully close, or partially close the indoor electronic expansion valve 642 based on the step signal.

Indoor unit controller 604 can be configured to control indoor fan 638. The indoor fan 638 can be configured to blow air over indoor coil 640. In this regard, the indoor unit controller 604 can control the amount of air blowing over the indoor coil 640 by generating control signals to control the speed and/or torque of the indoor fan 638. In some embodiments, the control signals are pulse wave modulated signals (PWM), analog voltage signals (i.e., varying the amplitude of a DC or AC signal), and/or any other type of signal. In one embodiment, the indoor unit controller 604 may receive a signal from the outdoor unit controller indicating one or more operating values, such as speed for the indoor fan 638. In one embodiment, the operating value associated with the indoor fan 638 is an airflow, such as cubic feet per minute (CFM). In one embodiment, the outdoor unit controller 606 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 604 may be electrically connected (e.g., wired connection, wireless connection, etc.) to pressure sensor 644 and/or temperature sensor 646. In this regard, the indoor unit controller 604 can take pressure and/or temperature sensing measurements via pressure sensor 644 and/or temperature sensor 646. In one embodiment, pressure sensor 644 and temperature sensor 646 are located on the suction line (i.e., a predefined distance from indoor coil 640). In other embodiments, the pressure sensor 644 and/or the temperature sensor 646 may be located on the liquid line (i.e., a predefined distance from indoor coil 640).

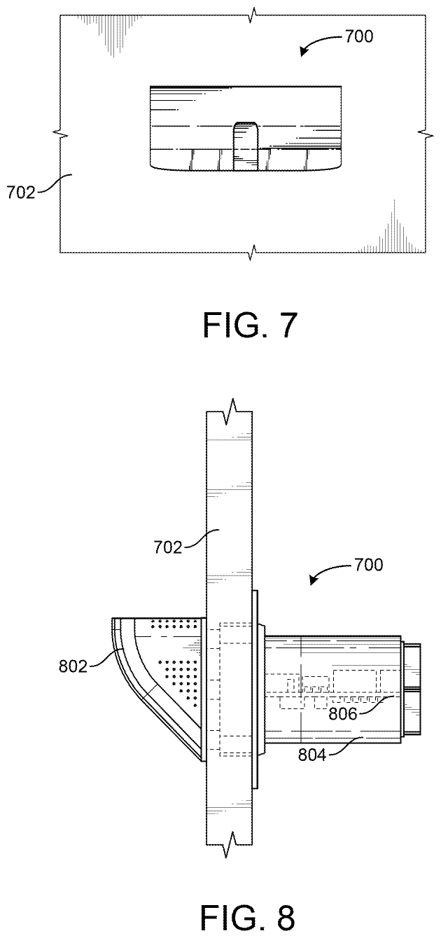

Referring now to FIGS. 7-8, a headless thermostat 700 is shown mounted on a wall 702, according to an exemplary embodiment. In FIG. 7, the headless thermostat 700 is shown to not include a display, i.e., the thermostat 700 is headless. A thermostat that does not include a display can reduce manufacturing costs since a manufacture does not need to spend resources on a display for the headless thermostat 700. Furthermore, displays often break due to accidental user damage or display component malfunctions. In this regard, a thermostat without a display, such as the headless thermostat 700 realize multiple benefits. Although the headless thermostat 700 does not include or require a display to operate, the headless thermostat 700 may operate the same as and/or similar to the thermostat 400 as described with reference to FIG. 4 and can include some or all of the components of the thermostat 400.

In FIG. 8, the headless thermostat 700 is shown extending through the wall 702. The headless thermostat 700 includes a cover 802 configured to house various electronics of the headless thermostat 700. The headless thermostat 700 further includes a socket 804 extending through and positioned at least partially behind the wall 702. The socket 804 includes various electronics including a circuit board 806.

### Virtual Thermostat

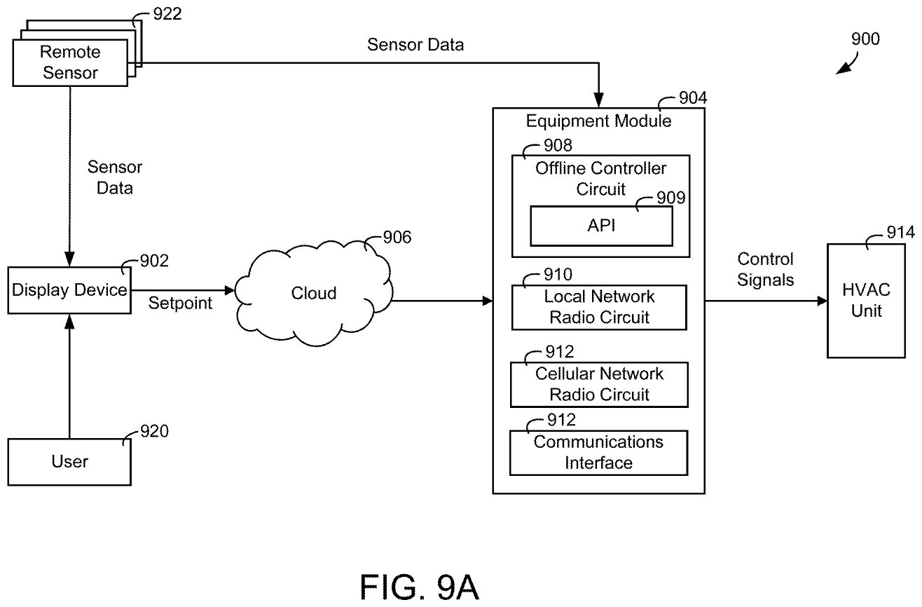

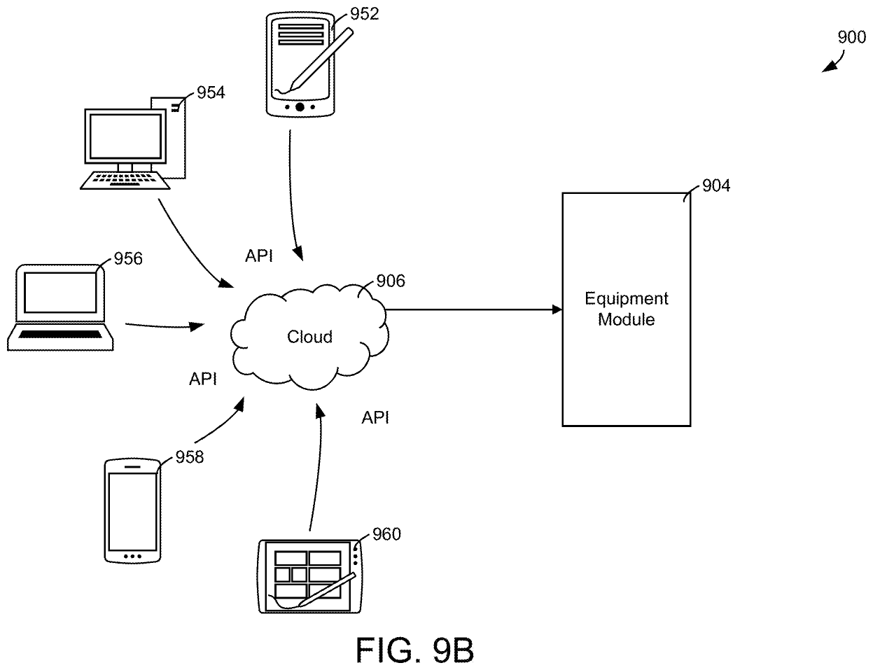

Referring now to FIG. 9A, a block diagram of system 900 for controlling an HVAC system is shown, according to an exemplary embodiment. System 900 may be incorporated partially or entirely into the various systems described herein. System 900 may be configured to provide HVAC control of a building (e.g., building 10) or building zone (e.g., a floor, a region of building 10, etc.) via cloud-based processing and control. Communication between the various devices within system 900 can be wired or wireless. For example, equipment module 904 may be wired directly to the HVAC units 914, while remote sensors 922 are wirelessly connected to display device 902. Wireless communication between devices in may include communication of any computer network type, including local area networks (LAN) (e.g., Wi-Fi, etc.), personal area networks (PAN) (e.g., Bluetooth®, Zigbee®, wireless USB, etc.), campus area network (CAN), wide area network (WAN), and cloud area network (IAN). System 900 is shown to include display device 902, equipment module 904, cloud 906, HVAC unit 914, remote sensors 922, and user 924.

Display device 902 may be configured to display information relating to system 900 to a user (e.g., user 924, etc.). In some embodiments, display device 902 only includes functionality relating to displaying information regarding system 900 and includes limited control functionality. For example, display device 902 may display the temperature recorded by sensors 922 on a screen of display device 902. A user may be able to view the current temperature, as well as the temperature setpoint established for the temperature in system 900.

In an exemplary embodiment, display device 902 receives a setpoint (e.g., temperature setpoint) directly from user 920. User 920 may engage with the interface on display device 902 (e.g., a touchscreen, a keypad, etc.) and enter a temperature setpoint. Display device 902 then provides the temperature setpoint to cloud 906 for processing. This includes cloud 906 receiving the temperature setpoint and providing instructions to equipment module 904 to adjust equipment (e.g., HVAC unit 914) in system 900 to achieve the setpoint.

In another exemplary embodiment, display device 902 receives temperature setpoints indirectly from a user (e.g., via a device, etc.). Display device 902 includes a communications interface that allows it to receive wireless signal communications. User 902 may, via a smartphone or other device, provide the setpoint wirelessly to display device 902. This process may be performed via a software application (e.g., an app on the smartphone, etc.) that allows display device 902 to receive setpoints via an application programming interface (API). In other embodiments, display device 902 can receive temperature setpoints via one or more personal area network (PAN) or local area network (LAN) devices, via Bluetooth®, Zigbee®, or Wi-Fi, or other wireless technology.

In another exemplary embodiment, display device 902 simply displays temperature information relating to system 900 and does not facilitate transition from a setpoint from user 920 to cloud 906. In such an embodiment, processing circuitry within cloud 906 (e.g., virtual thermostat 1202 as described below, etc.) may include the various communications interfaces and API interfaces to receive temperature setpoints via a user, or one or more user devices. An exemplified embodiment of cloud 906 receiving setpoints from various devices is described below in greater detail with reference to FIG. 9B.

In some embodiments, the communication between display device 902 and other components within system 900 are performed over a network. For example, display device 902 may communicate with equipment module 904 via a wireless connection, such that display device 902 can be installed with minimal wiring. Advantageously, this can allow for reduced wiring installation costs and simpler installation of display device 902.

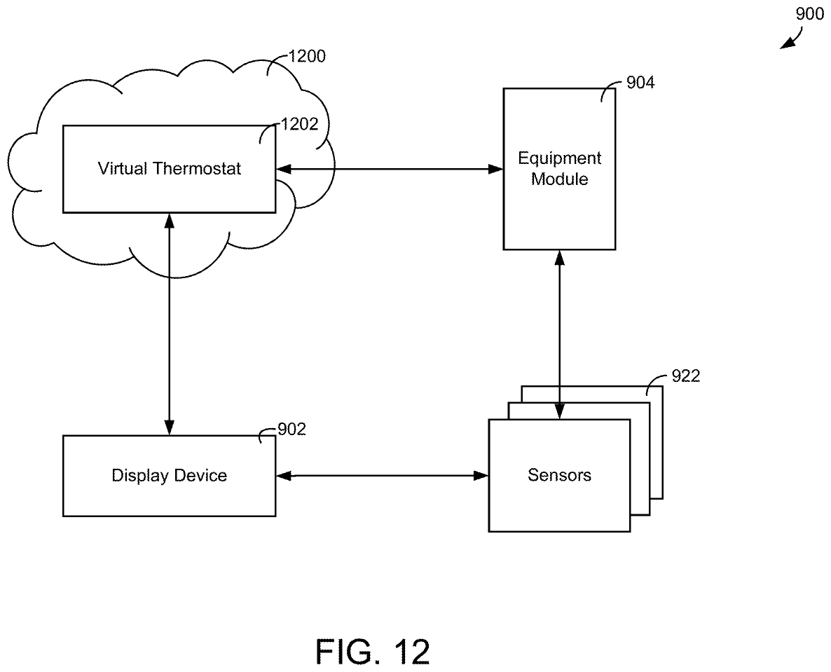

Cloud 906 may be include one or more interconnected networks that uses a network of remote servers to store, manage, and process data for system 900. In some embodiments servers and/or processing circuitry via cloud 906 receive instructions from a user (e.g., temperature setpoints from user 920, etc.) and provide control instructions to equipment module 904 to satisfy the user instructions. In some embodiments, cloud 906 includes a virtual thermostat. The virtual thermostat may be configured regulate the temperature, humidity, or other environmental parameter of system 900 to satisfy various setpoints. The functionality of a virtual thermostat within a cloud is discussed in greater detail below with reference to FIG. 12.

HVAC unit 914 may be equipment (e.g., heaters, chillers, air conditioning units, etc.) configured to heat and/or cool a building (e.g., building 10). For example, HVAC unit 914 can be the indoor unit 504 and/or the outdoor unit 506 as described with reference to FIG. 5. In some embodiments, HVAC unit 914 receives control signals from equipment module 904 wirelessly. For example, processing within equipment module 904 may be stored in a cloud-based server that is accessed over a network. HVAC unit 914 may be connected to a transceiver that can provide and receive signals from the cloud-based server over the network. In some embodiments, HVAC unit 914 refers to boilers, chillers, heat pumps, air handling units, furnaces, or any other device capable of changing an environmental parameter within system 900.

Equipment module 904 may be configured to receive instructions from an HVAC control device (e.g., a thermostat, a virtual thermostat in cloud 906, etc.) and adjust HVAC equipment to satisfy the instructions. Equipment module 904 may be connected to various other components (e.g., HVAC unit 914, device 920) over a building network (not shown in FIG. 9). The building network may be a Wi-Fi network, a wired Ethernet network, a Zigbee network, a Bluetooth network, and/or any other wireless network. The building network may be a local area network or a wide area network (e.g., the Internet, a building WAN, etc.) and may use a variety of communications protocols (e.g., BACnet, IP, LON, etc.). The building network may include routers, modems, and/or network switches. Furthermore, the network may be a combination of wired and wireless networks. Equipment module 904 is shown to include offline controller 908 including API interface 909, local network radio circuit 910, cellular network radio circuit 912, and communications interface 912.

Offline controller circuit 908 can be configured to act as a logic backup when the building network and/or the cellular network and/or the cellular network radio circuit 912 is not operating properly or is not present. Offline controller circuit 908 can include control logic for operating the HVAC unit 914 when the equipment module 904 cannot communicate with servers within cloud 906 and receive control signals, and/or environmental information. In some embodiments, offline controller circuit 908 includes control logic for operating the HVAC unit 914 even when equipment module 904 cannot communicate with remote sensors 922. Offline controller circuit 908 can include a local temperature sensor and can be digital and/or a hardwired circuit configured to keep the HVAC unit 914 operating a building at safe and/or comfortable environmental conditions.

In some embodiments, offline controller circuit 908 acts as a failsafe when processing circuitry within cloud 906 fails. For example, a virtual thermostat located within cloud 906 is regulating the temperature of system 900. The virtual thermostat malfunctions, and offline controller circuit obtains the control and functionality to regulate the temperature of system 900. In the event that the virtual thermostat within cloud 906 regains functionality and is capable of operating correctly, offline controller circuit 908 may relieve itself of control and give control back to the virtual thermostat in cloud 906. Local network radio circuit 910 may be configured to cause equipment module 904 to communicate via the building network while the cellular network radio circuit 912 can be configured to cause the equipment module 904 to communicate with a cellular network (e.g., network connected to device 920). Offline controller circuit 908 is shown to include API interface 909.

Application programming interface 909 may facilitate communication between offline controller circuit 908 and servers within cloud 906. For example, API 909 allows a virtual thermostat located 100 miles away to interface with equipment module 904 (e.g., via cloud 906). In another embodiment, API 909 allows various other devices to interface with equipment module 904 via one or more applications. For example, user 920 may engage with a smartphone application for controlling temperatures in system 900. User 920 may request information relating to the equipment devices (e.g., boilers, chillers, etc.) in system 900, wherein the application pings API 904 for device information and provides it to the user.

In some embodiments the relationship between system 900 and the servers within cloud 906 are based on a subscription based service. In some embodiments, this includes a payment structure that allows a customer or organization (e.g., user 920, etc.) to purchase or subscribe to a vendor's IT services (e.g., a vendor providing storage/processing on servers in cloud 906) for a specific period of time for a set price. In such an embodiment, user 920 connects to offline controller circuit 908 wired or wirelessly to configure it to communicate with the virtual thermostat in cloud 906. The virtual thermostat may include one or more servers that are provided via a subscription that user 920 pays. The vendor that supplies the servers in cloud 906 for controlling system 900 may provide other services for the customer too, such as data logging, trend analysis, forecasting, alarm notifications, and storage.

Communications interface 912 can facilitate communications between equipment module 904 and other devices (e.g., HVAC unit 914, remote sensors 922, display device 902, cloud 906, etc.) for allowing control, monitoring, and adjustment to equipment module 904. Interface 912 can be or include wired or wireless communications interfaces (e.g., jacks, antennas, transmitters, receivers, transceivers, wire terminals, etc.) for conducting data communications with cloud 906 or other external systems or devices. In various embodiments, communications via interface 912 can be direct (e.g., local wired or wireless communications) or via a communications network (e.g., a WAN, the Internet, a cellular network, etc.). For example, interface 912 can include an Ethernet card and port for sending and receiving data via an Ethernet-based communications link or network. In another example, interface 912 can include a Wi-Fi transceiver for communicating via a wireless communications network. In another example, interface 912 can include cellular or mobile phone communications transceivers. In one embodiment, interface 912 is a power line communications interface.

Referring now to FIG. 9B, another embodiment of system 900 is shown, according to an exemplary embodiment. System 900, as shown in FIG. 9B, shows several devices 952-962 communicating with cloud 906. Particularly, system 900 is shown to include personal digital assistant (PDA) (e.g., handheld PC, etc.), workstation 954, laptop 956, mobile device 958 (e.g., smartphone, cellphone, etc.), and tablet 960. In some embodiments, cloud 906 is not restricted to receiving information (e.g., setpoints, temperature setpoints, control instructions, etc.) from display device 902, as shown in FIG. 1. Severs and/or processing circuitry located in cloud 906 may include one or more API's for allowing interfacing between devices 952-960 and control circuitry in cloud 906 (e.g., a virtual thermostat as shown in FIG. 12 below, etc.).

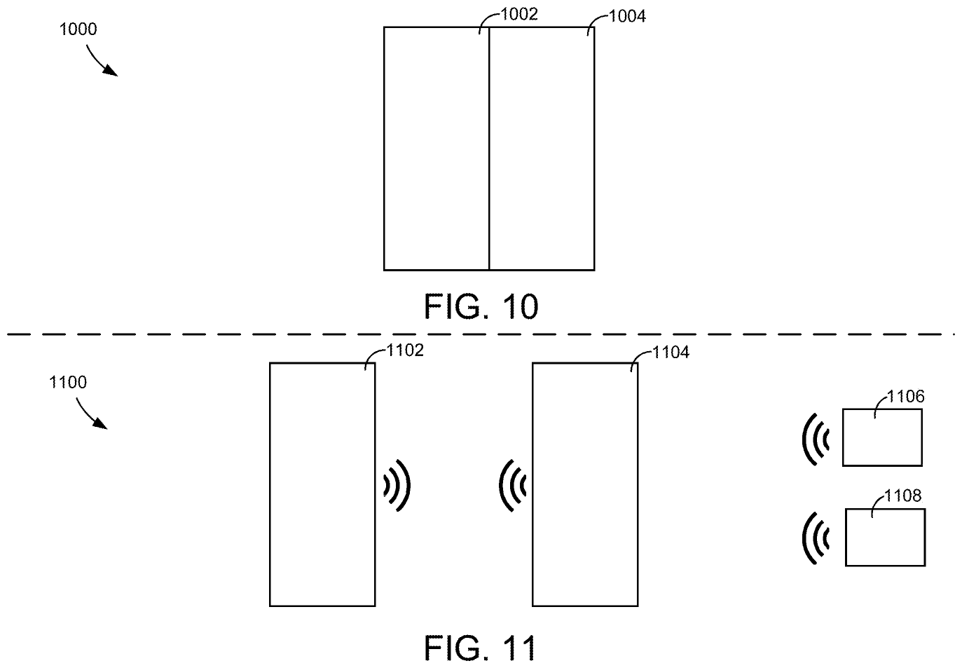

Referring now to FIG. 10-11, various embodiments of a thermostat are shown, according to some embodiments. Referring particularly to FIG. 10, thermostat 1000 is shown. Thermostat 1000 may represent a “connected” thermostat and include some or all of the functionality of a thermostat as disclosed herein. Thermostat 1000 is shown to include display device 1002 and equipment module 1004. In some embodiments, FIG. 10 shows a high-level diagram for a non-virtual (e.g., connected) thermostat. In such an example, the display components (e.g., display device 902 as shown in FIG. 9) and the processing components (e.g., equipment module 904 as shown in FIG. 9) and mechanically and electrically coupled into a single control device (e.g., a single thermostat).

Referring now to FIG. 11, a system 1100 of a thermostat is shown, according to an exemplary embodiment. System 1100 may be incorporated partially or entirely within system 900. System 1100 is shown to include display device 1102 and equipment module 1104. Display device 1102 and equipment module 1104 are shown to be separated into two distinct modules that communicate wirelessly. In some embodiments, display device 1102 and equipment module 1104 are similar in both functionality and communication as display device 902 and equipment module 904 as described above with reference to FIG. 9. Display device 1102 may be substantially similar or identical to display device 902 as shown in FIG. 9. Equipment module 1104 may be substantially similar or identical to equipment module 904 as shown in FIG. 9. FIG. 11 is further shown to include sensors 1106, 1108 communicating wirelessly with other components in system 1100.

Referring now to FIGS. 12-14, several variations of system 900 are shown, according to exemplary embodiments. The components and configurations disclosed in FIGS. 12-14 may be incorporated partially or entirely within system 900. Referring particularly to FIG. 12, a block diagram of system 900 with a virtual thermostat is shown, according to an exemplary embodiment. System 900 is shown to include display device 902, sensors 922, equipment module 904, virtual thermostat 922, and cloud network 1200.

Cloud network 1200 may include various cloud-based servers configured to handle processing, monitoring, analyzing, or any other functionality for system 900 off-premises. The functionality of cloud network 1200 is described in greater detail below. Cloud network 1200 is shown to include virtual thermostat 1202. Virtual thermostat 1202 may be configured to act as a virtual (e.g., cloud-based) representation of the processing performed by both display device 902 and equipment module 904. In some embodiments, “virtual” as used herein may refer to the processing for the thermostat functionality being located off-premises (e.g., in the cloud, in a server off-premises, etc.).

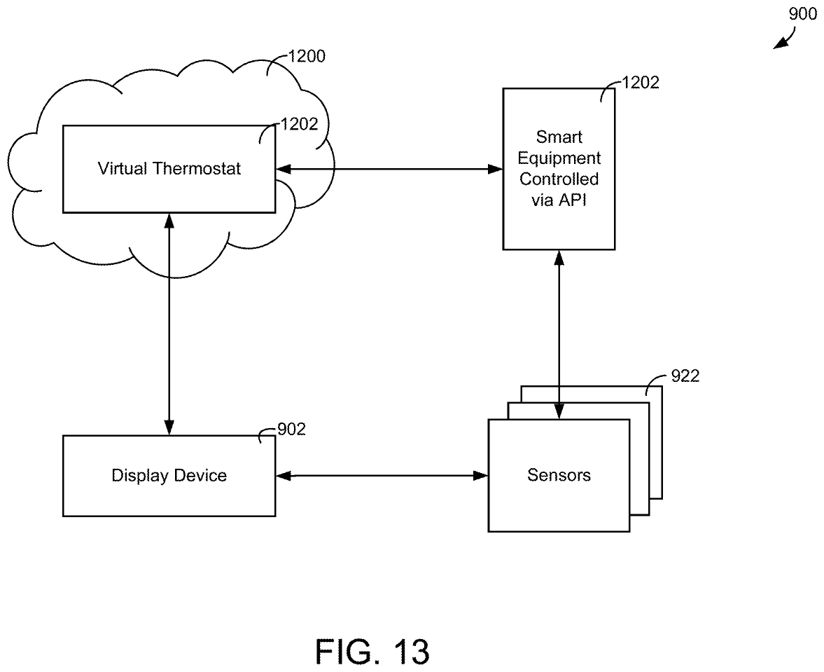

Referring now to FIG. 13, another block diagram of system 900 is shown, according to an exemplary embodiment. System 900 is shown to include “Smart Equipment controlled via API” module 1302. In some embodiments, system 900 may include various smart equipment (e.g., HVAC unit 914) that is controlled by virtual thermostat 1202 via an application programming interface (API). In some embodiments, module 1202 is performed by virtual thermostat 1202.

As described above with reference to FIG. 9A, module 1302 may facilitate communication between virtual thermostat 1202 and one or more applications within system 900, such as display device 902 sending setpoints to virtual thermostat 1202 or user 920 providing instructions to virtual thermostat 1202 via a smartphone. Module 1303 may also be configured to allow interfacing between equipment module 904, display device 902, devices 952-960, or any combination thereof.

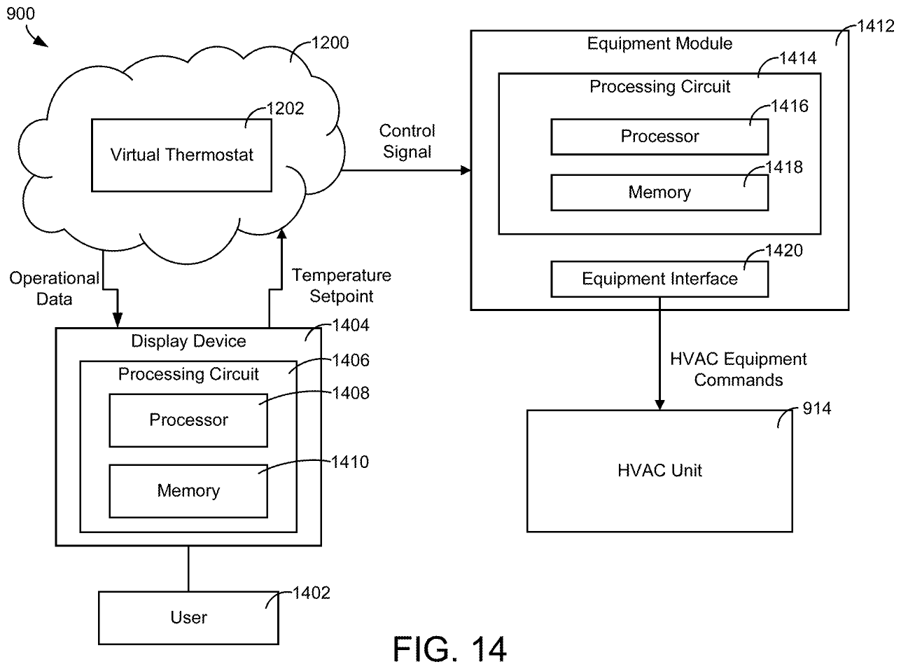

Referring now to FIG. 14, another block diagram of system 900 is shown, according to an exemplary embodiment. FIG. 14 may be a more detailed block diagram of system 900 as than those shown in FIGS. 12-13. FIG. 14 is shown to include cloud network 1200, virtual thermostat 1202, display device 1404, equipment module 1412, and HVAC unit 914.

Display device 902 is shown to provide temperature setpoints to cloud network 1200 and receive operational data from cloud network 1200. Display device 902 is shown to include a processing circuit 1406 including a processor 1408 and memory 1410. Processing circuit 1406 can be communicably connected to a communications interface such that processing circuit 1406 and the various components thereof can send and receive data via the communications interface. Processor 1408 can be implemented as a general purpose processor, an application specific integrated circuit (ASIC), one or more field programmable gate arrays (FPGAs), a group of processing components, or other suitable electronic processing components.

Memory 1410 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1410 can be or include volatile memory or non-volatile memory. Memory 1410 can include database components, object code components, script components, or any other type of information structure for supporting the various activities and information structures described in the present application. According to an example embodiment, memory 1410 is communicably connected to processor 1408 via processing circuit 1406 and includes computer code for executing (e.g., by processing circuit 1406 and/or processor 1408) one or more processes described herein. In some embodiments, display device 1404 is implemented within a single computer (e.g., one server, one housing, etc.). In various other embodiments display device 1404 can be distributed across multiple servers or computers (e.g., that can exist in distributed locations).

User 1402 may be any type of commercial or residential user (e.g., homeowner, resident, HVAC technician, etc.) capable of viewing display device 1404. In some embodiments, user 1402 may view display device 1404 after being installed in a home. In other embodiments, display device 1404 includes a monitor, phone application, or other medium for viewing information relating to viewing operational information regarding system 900.

Equipment module 1412 is shown to include equipment interface 1420 and processing circuit 1414 including a processor 1416 and memory 1418. Processing circuit 1414 can be communicably connected to a communications interface such that processing circuit 1414 and the various components thereof can send and receive data via the communications interface. Processor 1416 can be implemented as a general purpose processor, an application specific integrated circuit (ASIC), one or more field programmable gate arrays (FPGAs), a group of processing components, or other suitable electronic processing components.

Memory 1418 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1418 can be or include volatile memory or non-volatile memory. Memory 1418 can include database components, object code components, script components, or any other type of information structure for supporting the various activities and information structures described in the present application. According to an example embodiment, memory 1418 is communicably connected to processor 1418 via processing circuit 1414 and includes computer code for executing (e.g., by processing circuit 1414 and/or processor 1416) one or more processes described herein. In some embodiments, equipment module 1412 is implemented within a single computer (e.g., one server, one housing, etc.). In various other embodiments equipment module 1412 can be distributed across multiple servers or computers (e.g., that can exist in distributed locations).

In some embodiments, sensors 922 can be mobile sensors. In some embodiments, the mobile sensors 922 (FIG. 13) or devices worn or associated with users. The mobile sensors 922 can provide occupancy information to the virtual thermostat 1202 as well as temperature data. In some embodiments, the mobile sensors are user smart phones or employee badges that include temperature sensing devices.

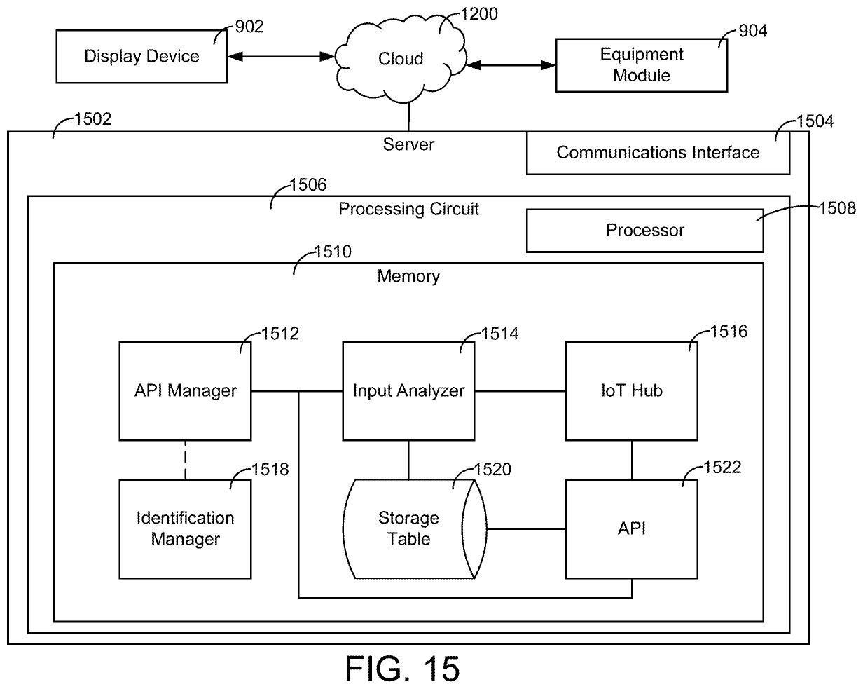

Referring now to FIG. 15, a block diagram of server 1502 connected to cloud network 1200 is shown, according to an exemplary embodiment. Server 1502 may be located off-premise (e.g., off-site, located in a different building than the end-user, etc.) and accessed via cloud 1200. In some embodiments, equipment module 904 and display device 902 receive information from server 1502 via cloud network 1200.

Server 1502 is shown to include communications interface 1504 and processing circuit 1506. Processing circuit is shown to include processor 1508 and memory 1510. Processing circuit 1506 can be communicably connected to a communications interface such that processing circuit 1506 and the various components thereof can send and receive data via the communications interface. Processor 1508 can be implemented as a general purpose processor, an application specific integrated circuit (ASIC), one or more field programmable gate arrays (FPGAs), a group of processing components, or other suitable electronic processing components.

Memory 1510 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 1510 can be or include volatile memory or non-volatile memory. Memory 1510 can include database components, object code components, script components, or any other type of information structure for supporting the various activities and information structures described in the present application. According to an example embodiment, memory 1510 is communicably connected to processor 1508 via processing circuit 1506 and includes computer code for executing (e.g., by processing circuit 1506 and/or processor 1508) one or more processes described herein. In some embodiments, equipment module 904 is implemented within a single computer (e.g., one server, one housing, etc.). In various other embodiments equipment module 904 can be distributed across multiple servers or computers (e.g., that can exist in distributed locations). Memory is shown to include API manager 1512, input analyzer 1514, IoT Hub 1516, identification manager 1518, storage table 1520, and API 1522.

Communications interface 1504 can facilitate communications between server 1504 and equipment module 904 and/or display device 902 for allowing control, monitoring, and adjustment to equipment module 904. Interface 1504 can be or include wired or wireless communications interfaces (e.g., jacks, antennas, transmitters, receivers, transceivers, wire terminals, etc.) for conducting data communications with cloud 1200 or other external systems or devices. In various embodiments, communications via interface 1504 can be direct (e.g., local wired or wireless communications) or via a communications network (e.g., a WAN, the Internet, a cellular network, etc.). For example, interface 1504 can include an Ethernet card and port for sending and receiving data via an Ethernet-based communications link or network. In another example, interface 1504 can include a Wi-Fi transceiver for communicating via a wireless communications network. In another example, interface 1504 can include cellular or mobile phone communications transceivers. In one embodiment, interface 1504 is a power line communications interface.

API manager 1512 may be configured to manage a set of functions or procedures that allow for a creation of one or more applications based on information stored in server 1502. In some embodiments, API manager 1512 manages a set of protocols that allow server 1502 to communicate with a client device (e.g., display device 902) via one or more applications. Input analyzer 1514 may receive one or more sets of data for processing. Internet of Things (IoT) Hub 1516 may be configured to act as a central message hub for bi-directional communication between an IoT application and one or more devices (e.g., display device 902). Identification manager 1518 may be configured to manage various device ID's or other identifications within system 900. Storage table 1520 may be configured to store data from input analyzer 1514. In some embodiments, storage table 1520 stores data relating to the temperature parameters of system 900. Application programming interface (API) 1522 may act as the module for facilitating communication between server 1502 and a client device (e.g., equipment module 904, etc.) via one or more applications.

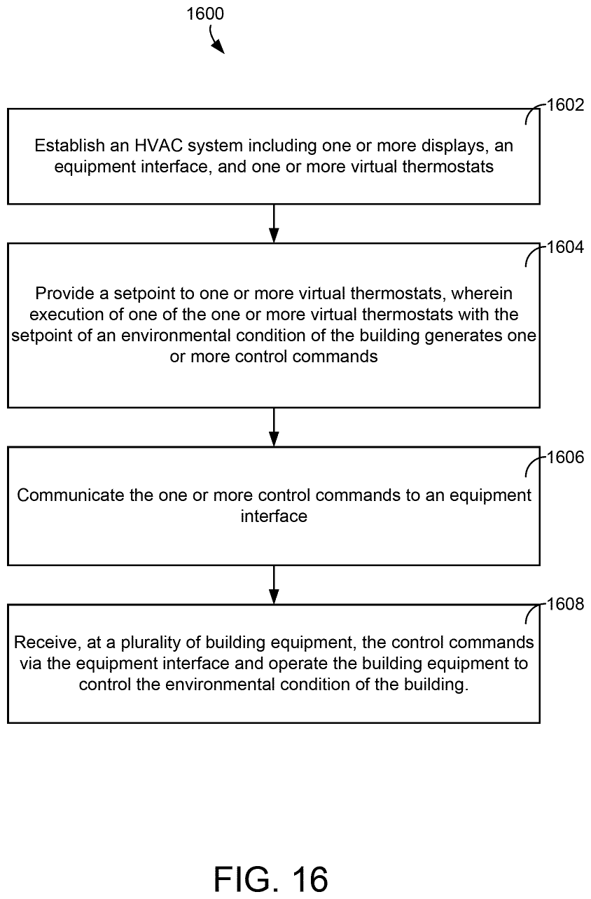

Referring now to FIG. 16, a process 1600 is shown for controlling an HVAC system in a building is shown, according to an exemplary embodiment. Process 1600 may be performed by various equipment in system 900 (e.g., display device 902, virtual thermostat 1202, etc.). Process 1600 is shown to include establishing an HVAC system including a display device, an equipment interface, and one or more virtual thermostats (step 1602). The display device, equipment interface, and one or more virtual thermostats may be similar to display device 902, equipment interface 1420, and virtual thermostat 1202 as described above.

Process 1600 is shown to include providing a setpoint to one or more virtual thermostats, wherein execution of one of the one or more virtual thermostats with the setpoint of an environmental condition of the building generates one or more control commands (step 1604). In some embodiments, the one or more virtual thermostats are located in a cloud network (e.g., cloud network 1200) and the display device is a smart display device configured to communicate with the virtual thermostat via the cloud network. The display device may be configured to receive operational data of the building HVAC system from the virtual thermostat.

Process 1600 is shown to include communicating the one or more control commands to an equipment interface (step 1606). This may be performed by virtual thermostat 1202 such that virtual thermostat 1202 provides control signals to equipment module 1412 as shown in FIG. 14. In some embodiments, the one or more control commands include commands to adjust HVAC equipment that will alter the temperature within a system 900 (e.g., a building zone within system 900) to reach a temperature setpoint. Process 1600 is shown to include receiving, at a plurality of building equipment, the control commands via the equipment interface and operate the building equipment to control the environmental condition of the building (step 1608). In some embodiments, equipment module 1412 provides HVAC unit 914 with HVAC equipment commands.

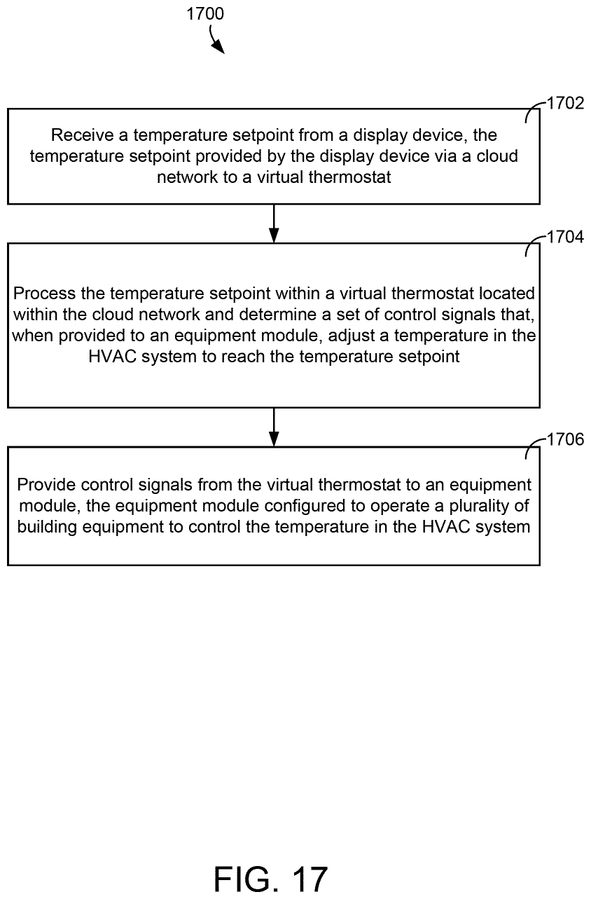

Referring now to FIG. 17, a process 1700 for controlling an HVAC system via one or more thermostats is shown, according to an exemplary embodiment. Process 1700 may be performed by server 1502, as shown in FIG. 15. Process 1700 is shown to include receiving a temperature setpoint from a display device, the temperature setpoint provided by the display device via a cloud network to a virtual thermostat (step 1702). In some embodiments, server 1504 receives temperature measurements of system 900 or another HVAC system disclosed herein. The measurements may receive via a cloud network (e.g., cloud 1200) such that server 1504, located off-premise, is connected to system 900 via a collection of interconnected networks (e.g., cloud 1200, etc.). In some embodiments, the processing for a “virtual thermostat” includes processing that is provided over a network (e.g., at another computer at a separate location). In such an embodiment, this may include server 1502 acting as a virtual thermostat for the systems disclosed herein. Server 1504 may be configured to receive various data relating to system 900 and is not limited to temperature, such as humidity data and air quality data.

Process 1700 is shown to include processing the temperature setpoint within a virtual thermostat located within the cloud network and determine a set of control signals that, when provided to an equipment module, adjust a temperature in the HVAC system to reach the temperature setpoint (step 1704). Additionally, process 1700 is shown to include providing control signals from the virtual thermostat to an equipment module, the equipment module configured to operate a plurality of building equipment to control the temperature in the HVAC system (step 1706).

In some embodiments, server 1502 processes the received temperature data and provides information back to system 900 (e.g., display device 902, equipment module 904, etc.) via cloud 1200. For example, after processing the temperature data, server 1502 (e.g., a virtual thermostat) may provide control signals to equipment module 904 that satisfies one or more temperature setpoints. In another example, after processing the temperature data, server 1502 may provide information to display device 902 that displays the status, temperatures, and activity of system 900.

In some embodiments, process 1700 may include receiving, via a display device, instructions to provide a change a temperature setpoint in the building HVAC system. In some embodiments, process 1700 includes providing, via the display device, the temperature setpoint to the one or more virtual thermostats via the cloud network. In some embodiments, process 1700 includes communicating one or more control commands to the equipment interface via the plurality of predefined communications rules. This may include interfacing via one or more application programming interfaces (API).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building heating, ventilation or air conditioning (HVAC) system, the building HVAC system comprising:
a display device comprising a first processing circuit, the first processing circuit configured to:
provide a setpoint to one or more virtual controllers, wherein execution of one of the one or more virtual controllers with the setpoint of an environmental condition of the building generates one or more control commands; and
provide the one or more control commands to a building equipment; and
the building equipment configured to receive the one or more control commands to control the environmental condition of the building.

2. The HVAC system of claim 1, wherein providing a setpoint to one or more virtual controllers comprises providing at least one of a temperature, position, fluid flow, rotation, or air quality setpoint to one or more virtual controllers.

3. The HVAC system of claim 1, wherein:
the display device comprises a user interface for receiving the setpoint, wherein the display device is a wall-mounted thermostat display or a mobile device or a computer;
the building equipment is a furnace or boiler or chiller or heater; and
the one or more virtual controllers are virtual thermostats.

4. The HVAC system of claim 1, wherein the system further comprises a building equipment interface configured to:
receive the one or more control commands via the one or more virtual controllers; and
operate the building equipment to achieve the setpoint.

5. The HVAC system of claim 4, wherein the building equipment and the equipment interface are at least one of:
separate devices, wherein the building equipment is connected to the equipment interface via one or more communication wires; or
integrated together, wherein the equipment interface is a component of the building equipment.

6. The HVAC system of claim 5, wherein the processing circuit of the device and the equipment interface are each configured to implement a communication interface module comprising a plurality of predefined communication rules, wherein the processing circuit is configured to communicate one or more control commands to the equipment interface via the plurality of predefined communications rules.

7. The HVAC system of claim 1, wherein:
the one or more virtual controllers are located in a cloud network;
the display device is a smart display device configured to communicate with the virtual thermostat via the cloud network, the display device configured to receive operational data of the building HVAC system from the virtual controller.

8. The HVAC system of claim 1, wherein:
the display device is located on premises such that the building equipment and the display device are located in a same building; and
the building HVAC system further comprises one or more sensors configured to provide sensor data for the setpoint of an environmental condition and provides the sensor data to the virtual controller via the cloud network.

9. The HVAC system of claim 1, wherein the processing circuit is configured to:
receive an indication to instantiate a plurality of virtual controllers for one or more buildings; and
execute each of the plurality of virtual controllers to generate particular control decisions for each of the plurality of virtual controllers.

10. The building system of claim 6, wherein the communication interface module comprises an application programming interface (API).

11. A method for controlling a building heating, ventilation, or air conditioning (HVAC) system, the method comprises:
receiving a setpoint from a display device, the temperature setpoint provided by the display device via a cloud network to a virtual controller;
processing the setpoint within a virtual controller located within the cloud network and determine a set of control signals that, when provided to a building equipment, adjust a temperature in the HVAC system to reach the setpoint;
providing control signals from the virtual controller to the building equipment to control the environmental condition of the building.

12. The method of claim 11, wherein:
the display device comprises a user interface for receiving the setpoint, wherein the display device is a wall-mounted thermostat display or a mobile device or a computer;
the building equipment is a furnace or boiler or chiller or heater; and
the one or more virtual controllers are virtual thermostats.

13. The method of claim 11, further comprising:
receiving, via a display device, instructions to provide a change a temperature setpoint in the building HVAC system; and
providing, via the display device, the temperature setpoint to the one or more virtual thermostats via the cloud network; and
wherein the virtual controller is a virtual thermostat.

14. The method of claim 11, wherein:
the display device is located on premises such that the building equipment and the display device are located in a same building; and
the building HVAC system further comprises one or more sensors configured to provide sensor data for the setpoint of an environmental condition and provides the sensor data to the virtual controller via the cloud network.

15. The method of claim 11, wherein the system further comprises a building equipment interface configured to:
receive the one or more control commands via the one or more virtual controllers; and
operate the building equipment to achieve the setpoint.

16. The method of claim 15, wherein the building equipment and the equipment interface are at least one of:
separate devices, wherein the building equipment is connected to the equipment interface via one or more communication wires; or
integrated together, wherein the equipment interface is a component of the building equipment.

17. The method of claim 11, further comprising implementing a communication interface module comprising a plurality of predefined communication rules; and
communicating one or more control commands to the equipment interface via the plurality of predefined communications rules.

18. The method of claim 17, wherein the communication interface module comprises an application programming interface (API).

19. A thermostat for a heating, ventilation, or air conditioning (HVAC) system, the thermostat comprising:
a processing circuit comprising one or more processors and memory storing instructions that, when executed by the one or more processors, cause the one or more processors to perform operations comprising:
receiving a temperature setpoint from a display device, the temperature setpoint provided by the display device via a cloud network to a virtual thermostat;
processing the temperature setpoint within a virtual thermostat located within the cloud network and determining a set of control signals that, when provided to an equipment module, adjust a temperature in the HVAC system to reach the temperature setpoint;
providing control signals from the virtual thermostat to an equipment module, the equipment module configured to operate a plurality of building equipment to control the temperature in the HVAC system.

20. The thermostat of claim 19, further comprising:
receiving, via a display device, instructions to provide a change a temperature setpoint in the building HVAC system; and
providing, via the display device, the temperature setpoint to the one or more virtual thermostats via the cloud network.
